(19) United States
(12) Patent Application Publication
(10) Pub. No.: US 2022/0366500 A1
(43) Pub. Date: Nov. 17, 2022

(54) METHODS AND SYSTEMS FOR DIGITALLY TRANSFORMING RESEARCH AND DEVELOPMENTAL DATA FOR GENERATING BUSINESS INTELLIGENCE DATA

(71) Applicant: GMA Digital Transformation LLC, Woodbury, MN (US)

(72) Inventor: Richard Yufeng LIU, Woodbury, MN (US)

(21) Appl. No.: 17/322,664

(22) Filed: May 17, 2021

(51) Int. Cl. G06Q 40/06; G06N 20/00; G06Q 10/06

(52) U.S. Cl. CPC G06Q 40/06; G06N 20/00; G06Q 10/06375

(57) ABSTRACT

Methods and systems for digitally transforming research and developmental data for generating business intelligence data are described. The method performed by a data analytics system includes accessing research and developmental data from a data source and converting the research and developmental data into a machine-understandable format. The method includes analyzing the research and developmental data to obtain operational distribution of risk, uncertainties, and resource demand, via a mathematical engine. The method includes quantifying unit return on investment (ROI) based, at least in part, on research and developmental investment and operational deficiency and transforming research and developmental data for visualization, optimization, and distribution mapping of efficiency, productivity, and cost, via an analytical engine. The method includes forecasting emerging product opportunities and future new product sales via a predictive engine. The method includes facilitating visualization of business intelligence data in real-time on a user device via an artificial intelligence/machine learning (AI/ML) engine.

### TECHNICAL FIELD

The present disclosure relates to the computer technology and, more particularly to, electronic methods and complex processing systems for digitally transforming research and developmental data for predictive analytics, visualization, optimization and distribution mapping of risks & uncertainties, efficiency, productivity, new product opportunities, return on investment, and cost.

### BACKGROUND

There have been numerous qualitative studies, stories, history, and books on the management of research and developmental data for technology innovations. Many strategies, theories, empirical rules, and principles have been proposed and documented for what makes a highly efficient research and development (R&D) operation to sustain organic growth in the long run. These techniques have failed over time due to a lack of quantitative understanding of a large amount of research and developmental data, other operational data, and subsequent correlation with financial results.

In conventional solutions, R&D operational efficiency and productivity enhancement tasks would take months and years of R&D and other operational experience. The resulted learning can potentially get lost in the time of generational leadership changes since this becomes a very long process. Even though experimenting with artificial intelligence (AI) and Machine Learning (ML) to try to optimize business processes has begun in the market for a while, unfortunately, most companies face tremendous difficulty in moving beyond AI experiments and prototypes. The reason is their lack of realistic and accurate R&D and other operational models that govern the rules of the AI and ML models.

In light of the above discussion, there is a need for technical solutions for digitally transforming the research and developmental data for generating business intelligence data.

### SUMMARY

Various embodiments of the present disclosure provide methods and systems for digitally transforming research and developmental data to generate business intelligence data.

In an embodiment, a data analytics system is disclosed. The data analytics system includes a communication interface, a memory including executable instructions, and a processor communicably coupled to the communication interface and the memory. The processor includes a data-processing engine, a mathematical engine, an analytical engine, a predictive engine, an artificial intelligence/machine learning (AI/ML) engine, or a combination thereof. The data pre-processing engine is operable to access research and developmental data from a data source and convert the research and developmental data into a machine-understandable format. The mathematical engine is operable to analyze the research and developmental data to obtain operational distribution of risk, uncertainties, and resource demand. The analytical engine is operable to quantify a unit return on investment (ROI) on research and developmental investment and operational deficiency and to transform research and developmental data for visualization, optimization, and distribution mapping of efficiency, productivity, and cost. The predictive engine is operable to forecast emerging product opportunities and future new product sales. The AI/ML engine is operable to facilitate visualization of business intelligence data in real-time on a user device. The business intelligence data may be generated using the research and developmental data.

In yet another embodiment, a computer-implemented method is disclosed. The computer-implemented method performed by a data analytics system includes accessing research and developmental data from a data source and converting the research and developmental data into a machine-understandable format. The method includes analyzing the research and developmental data to obtain operational distribution of risk, uncertainties, and resource demand, via a mathematical engine. The method includes quantifying unit return on investment (ROI) based, at least in part, on research and developmental investment and operational deficiency, via an analytical engine. The method includes transforming research and developmental data for visualization, optimization, and distribution mapping of efficiency, productivity, and cost, via the analytical engine. The method further includes forecasting emerging product opportunities and future new product sales, via a predictive engine. The method includes facilitating visualization of business intelligence data in real-time on a user device via an AI/ML engine. The business intelligence data may be generated using the research and developmental data.

In yet another embodiment, a computer-implemented method to digitally transform research and developmental data for generating business intelligence data is disclosed. The computer-implemented method performed by a data analytics system includes accessing research and developmental data from a data source and converting the research and developmental data into business metrics and targets. The method includes analyzing the research and developmental data, via a mathematical engine. The method further includes quantifying on return of research and developmental investment and operational deficiency, via an analytical engine. The method includes transforming the research and developmental data, via the analytical engine. The method further includes forecasting emerging product opportunities and future new product sales, via a predictive engine. The method includes facilitating visualization of business intelligence data in real-time on a user device via an AI/ML engine. The business intelligence data is digitally transformed from the research and developmental data,

### BRIEF DESCRIPTION OF THE FIGURES

For a more complete understanding of example embodiments of the present technology, reference is now made to the following descriptions taken in connection with the accompanying drawings in which:

FIG. 1 is an example representation of an environment related to at least some examples of the present disclosure;

FIG. 2 is an exemplary block diagram representation of a data analytics system, in accordance with an embodiment of the present disclosure;

FIG. 3A is a block diagram representation of some of the possible risk and uncertainties in the R&D of a new product, in accordance with an embodiment of the present disclosure;

FIG. 3B is a block diagram representation of how the mathematical engine is used to optimize enterprise resource planning (ERP), in accordance with an embodiment of the present disclosure;

FIG. 4 is a two-dimensional graph representing a graph plotted for unit return on investment (ROI) distribution vs. forecasted opportunity size, in accordance with an example embodiment of the present disclosure;

FIGS. 5A and 5B are two-dimensional graphs that are output by an analytical engine of the data analytics system, in accordance with an embodiment of the present disclosure;

FIG. 6 is a flow diagram for forecasting new product sales by a predictive engine of the data analytics system, in accordance with an embodiment of the present disclosure;

FIGS. 7A and 7B are two-dimensional graphs that are output by a predictive engine of the data analytics system, in accordance with an embodiment of the present disclosure;

FIG. 8 is an exemplary block diagram of an AI/machine learning engine, in accordance with an embodiment of the present disclosure;

FIG. 9 is a flow diagram of a computer-implemented method for digitally transforming research and developmental data for generating business intelligence data, in accordance with an embodiment of the present disclosure;

FIGS. 10A-10C are exemplary tabular representations of input and output variables of the data analytics system as part of a Digital Twin, in accordance with an embodiment of the present disclosure;

FIG. 11 is an exemplary block diagram of an electronic device capable of implementing the various embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### Overview

Various embodiments of the present disclosure provide methods, systems electronic devices, and computer program products for digitally transforming the research and developmental data of a company for generating business intelligence data. The business intelligence data may include productivity, efficiency, unit return on investment, risk and uncertainty distribution, new product sale forecast, future opportunity mapping, portfolio optimization, and optimum resource allocation. The technical problem in existing solutions is that the digital transformation of research and developmental data of a firm does not incorporate a proper combination of mathematical, analytical, predictive models along with AI/ML models. The existing solutions are time-consuming and may get distracted during the long run. The quantification methods present in the existing solutions result in errors in a high margin. The generation of rules to be fed to the Artificial intelligence (AI) and machine learning (ML) models have taken a back seat in the existing solutions.

The present disclosure provides techniques and methodology for generating business intelligence data by digitally transforming research and developmental data accessed from a data source. The data source may be an R&D database, an enterprise database, and/or the like associated with a company performing R&D on one or more products. The research and developmental data may include new product size, new opportunity forecast size, research and development (R&D) resource scaling factor, R&D resource coefficient, minimum initial R&D resource required, probability of success for a new product, risk sensitivity coefficient, R&D efficiency, R&D productivity, new product sales, unit return on investment, number of new opportunities, year, quarter, R&D resource demand coefficient, minimum R&D resource required, initiation probability of success, voice of market, voice of customer, marketing forecast, R&D data, financial target, macroeconomic condition, competitions, sales, marketing & tech service, the number of new product launched, sales of each newly launched product, and the like.

The business intelligence data generated for the research and developmental data may include productivity, efficiency, unit return on investment, risk and uncertainty distribution, new product sale forecast, future opportunity mapping, portfolio optimization, optimum resource allocation, and the like.

In an example, the present disclosure describes a data analytics system that is configured to digitally transform the research and developmental data to generate business intelligence data. The data analytics system is configured to access the research and developmental data stored in a data source and convert the research and developmental data into machine-understandable format. The converted data may include data such as R&D metric and financial targets in an example embodiment. The conversion may be performed using data pre-processing techniques such as data mining, data transformation, data reduction, etc. Machine-understandable format of data refers to the format of data that can be fed as input to various models such as mathematical models, predictive models, AI/machine learning models, etc. The data may be expressed in a mathematical form, canonical form, matrix form, etc., based on the type of data that is accessed and the model that the data has to be fed into.

The data analytics system is configured to analyze the research and developmental data to obtain operational distribution of risk, uncertainties, and resource demand The data analytics system may utilize a mathematical model including a plurality of formulae to analyze the research and developmental data. The operational distribution of risk, uncertainties, and resource demand associated with the research and developmental data may be generated using the formulae included in the mathematical models.

In one embodiment, the data analytics system is configured to quantify unit return on investment (ROI) based on research and development investment and operational deficiency derived from the research and developmental data accessed from the data source. The data analytics system may transform the research and developmental data for visualization, optimization and distribution mapping of efficiency, productivity, and cost. The cost refers to the unit return on research and developmental investment. The data analytics system is further configured to determine distribution mapping of the unit return on research and developmental investment.

In one embodiment, the data analytics system is configured to forecast emerging product opportunities and future new product sales using predictive analysis. The predictive analysis may be performed by utilizing prediction algorithms Random variable inputs from the research and developmental data accessed from the data source may be provided to the prediction algorithms that determine the emerging product opportunities, and/or future new product sales.

In one embodiment, the data analytics system is configured to facilitate visualization of business intelligence data in real-time on a graphical user interface (GUI) of electronic devices such as a user device installed with an R&D data application provided by the data analytics system. The data analytics system is configured to utilize one or more AI/machine learning (ML) models that are trained to generate desired outputs based on the input provided to the models. In one embodiment, the data analytics system may be in communication with the GUI unit of a user device to facilitate real-time visualization of the business intelligence data generated by the data analytics system using the research and developmental data. The data analytics system may be configured to provide dashboards including graphs, tables, and the like that may or may not be interactive for visualization on the user device.

In an additional embodiment, the present disclosure may be extended to digitally transform various other data such as enterprise data, supply chain data, manufacturing data, and the like. Similar techniques may be implemented to generate business intelligence data by accessing the enterprise data, supply chain data, or manufacturing data from a data source associated with a corresponding company. The input variables provided to the various models described in the disclosure may be adjusted according to the type of data for which the business intelligence data is being generated.

Without in any way limiting the scope, interpretation, or application of the claims appearing below, technical effects of one or more of the example embodiments disclosed herein include, but are not limited to, provisioning near real-time provisioning of business intelligence data for visualization. The business intelligence data may be used in optimum resource allocation, new product sale forecast, future opportunity mapping, portfolio optimization, and the like. Since quantification of return on research and developmental investment is facilitated by the present disclosure, it facilitates higher return on R&D investments as companies can plan and allocate the resources to gain maximum returns. The present disclosure is prone to very little human error due to the utilization of mathematical formulae, prediction algorithms, analytical tools, and AI/ML models. The present disclosure also provides more accessibility of the generated business intelligence data since the real-time visualization is provided via an application installed on a remote device. Forecasting of future new product sales and emerging product opportunities provided by the present disclosure facilitates the companies to plan and optimize their sales and product launches. Demonstrating quantitative distribution of uneven return on R&D investment across different opportunities would not be obvious without the novel data analytics system incorporating the mathematical models disclosed herein.

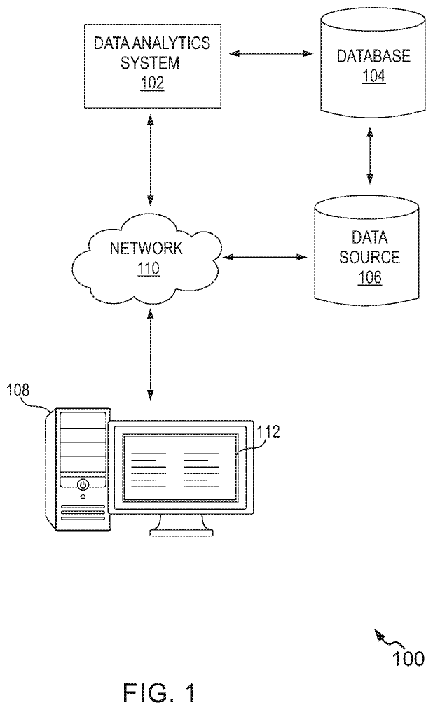

Various example embodiments of the present disclosure are described hereinafter with reference to FIGS. 1 to 11.

FIG. 1 is an example representation of an environment 100 related to at least some examples of the present disclosure. Although the environment 100 is presented in one arrangement, other embodiments may include the parts of the environment 100 (or other parts) arranged otherwise depending on, for example, a method for digitally transforming research and developmental data for generating business intelligence data such as future product sales, unit return on investment, etc. The environment 100 generally includes a data analytics system 102, a database 104, a data source 106, and a user device 108, associated with and in communication with (and/or with access to) a network 110. The network 110 may include, without limitation, a light fidelity (Li-Fi) network, a local area network (LAN), a wide area network (WAN), a metropolitan area network (MAN), a satellite network, the Internet, a fiber-optic network, a coaxial cable network, an infrared (IR) network, a radio frequency (RF) network, a virtual network, and/or another suitable public and/or private network capable of supporting communication among the entities illustrated in FIG. 1, or any combination thereof.

Various entities in the environment 100 may connect to the network 110 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, or any combination thereof. The network 110 may include, without limitation, a local area network (LAN), a wide area network (WAN) (e.g., the Internet), a mobile network, a virtual network, and/or another suitable public and/or private network capable of supporting communication among two or more of the entities illustrated in FIG. 1, or any combination thereof. For example, the network 110 may include multiple different networks, such as a private network made accessible by the data analytics system 102, the database 104, the data source 106, and the user device 108 separately, and/or a public network (e.g., the Internet) through which the data analytics system 102, the database 104, the data source 106, and the user device 108 may communicate. In some embodiments, the database 104, the data source 106, and the user device 108 may, for example, be connected to the data analytics system 102 via various wireless means such as, cell towers, routers, repeaters, ports, switches, and/or other network components that include the Internet and/or a cellular telephone (and/or Public Switched Telephone Network (PSTN)) network, and which include portions of the network 110.

In one embodiment the data source 106 and the database 104 may be directly connected via a private network. The R&D data, enterprise data, supply chain data, etc., associated with a company may be communicated between the database 104 and the data source 108 via a private network.

In one embodiment, the user device 108 may include any type or configuration of computing, mobile electronic, network, user, and/or communication devices that are or become known or practicable. Examples of the user device 108 include a mobile phone, a smart telephone, a computer, a laptop, a PDA (Personal Digital Assistant), a Mobile Internet Device (MID), a tablet computer, an Ultra-Mobile personal computer (UMPC), a phablet computer, a handheld personal computer and the like. Each user device may include an ultrasound sensor, a global position satellite transceiver, WiFi transceiver, mobile telephone components, and/or any suitable combination thereof. In some embodiments, the user device 108 may include a device owned and/or operated by the user (Not shown in the figure) of an online service. According to some embodiments, the user device 108 may communicate with the data analytics system 102 via the network 110, such as to register with a service provider, request for business intelligence data, view dashboards received from the data analytics system, etc.

In one embodiment, the data analytics system 102 may store a plurality of algorithms, mathematical models, AI/machine learning models, etc., required by the data analytics system to digitally transform research and developmental data associated with a company.

In one embodiment, the user device (e.g., the user device 108) is equipped with a research and development (R&D) data application 112, interchangeably referred to as “mobile application” throughout the description. The R&D data application 112 enables users to log in and view business intelligence data received from the data analytics system 102. The user device 108 may be any communication device having hardware components for enabling User Interfaces (UIs) of the R&D data application 112 to be presented on the user device 108. Real-time data visualization may be facilitated on the R&D data application 112 of the user device 108 via the data analytics system 102. A dashboard including a plurality of graphs and numerical data may be made available on the R&D data application 112 for viewers to view and interact.

In an embodiment, the data source 106 may be associated with a company or an organization that is performing R&D activities. The data related to the R&D being performed in the company may be stored in the data source 106. The data source 106 may be one of a local database associated with the organization, shared database accessible to one or more components associated in connection with the network 110 and/or database 104, cloud storage, and the like. The R&D data may be collected by and stored in data source 106 by customer relationship management (CRM) software installed on a server associated with the company or the organization (not shown in the Figures).

The research and developmental data accessed from the data source 106 may include new product size, new opportunity forecast size, research and development (R&D) resource scaling factor, R&D resource coefficient, minimum initial R&D resource required, probability of success for a new product, and risk sensitivity coefficient, R&D efficiency, R&D productivity, new product sales, unit return on investment, number of new opportunities, year, quarter, R&D resource demand coefficient, minimum R&D resource required, initiation probability of success, voice of market, voice of customer, marketing forecast, R&D data, financial target, macroeconomic condition, competitions, R&D data, sales, marketing & tech service, number of new product launched, and sales of each newly launched product.

In one embodiment, the data analytics system 102 is configured to access the research and developmental data stored in the data source 106 and convert the research and developmental data into machine-understandable format. The research and developmental data may be converted into R&D metrics and financial targets. The conversion may be performed using data pre-processing techniques such as data mining, data transformation, data reduction, etc. Machine-understandable format of data refers to the format of data that can be fed as input to models such as mathematical models, AI/machine learning models stored in the database 104. The data may be expressed in a mathematical form, canonical form, matrix format, etc., based on the type of data that is accessed and the model that the data has to be fed into.

The data analytics system 102 is configured to analyze the research and developmental data to obtain operational distribution of risk, uncertainties, and resource demand The data analytics system 102 may utilize a mathematical model stored in the database 104 to analyze the research and developmental data. The mathematical model may include a plurality of formulae that is capable of determining the operational distribution of risk, uncertainties, and resource demand associated with the research and developmental data.

In one embodiment, the data analytics system 102 is configured to quantify unit return on investment (ROI) based on research and developmental investment and operational deficiency that are derived from the research and developmental data accessed from the data source 106. The data analytics system 102 may further transform the research and developmental data for visualization, optimization and distribution mapping of efficiency, productivity, and cost. The cost refers to the unit return on research and developmental investment. The data analytics system 102 is configured to determine distribution mapping of the unit return on research and developmental investment.

The data analytics system 102 may forecast emerging product opportunities and future new product sales using predictive analysis. The predictive analysis may be performed by utilizing prediction algorithms stored in the data analytics system 102. Random variable inputs from the research and developmental data accessed from the data source 106 may be provided to the prediction models. The prediction algorithms may determine the emerging product opportunities, and/or future new product sales.

In one embodiment, the data analytics system 102 is configured to facilitate visualization of business intelligence data in real-time on the user device 108. The business intelligence data may include the outputs received from the mathematical model, prediction model, and the like such as R&D efficiency, R&D productivity, new product sales, unit return on R&D investment, etc. The data analytics system 102 is configured to utilize one or more AI/machine learning (ML) models in combination of the mathematical equations of the analytical model defined in this invention at its core stored in the data analytics system 102. The AI/ML models may be trained models that are configured to generate desired outputs based on the input provided to the models. The suitable AI/machine learning technique includes Convolutional Neural Network (CNN), Recurrent Neural Network (RNN), single and multi-variable regression, classification, clustering, patterning, anomaly detection, Deep Learning Neural Network (DLNN), or combination thereof. In one embodiment, the data analytics system 102 may be in communication with the UI of the user device 108 to facilitate real-time visualization of the business intelligence data generated by the data analytics system 102 using the research and developmental data. The data analytics system 102 may be configured to provide dashboards including graphs, tables, and the like that may or may not be interactive for visualization on the user device 108. The visualization may be facilitated via the R&D data application 112 installed on the user device 108.

In an additional embodiment, the data analytics system 102 may facilitate the digital transformation of various other data such as enterprise data, supply chain data, manufacturing data, and the like. Similar techniques described above may be implemented to generate business intelligence data by accessing the enterprise data, supply chain data, or manufacturing data from a data source such as the data source 106. The input variables provided to the data analytics system 102 for the generation of business intelligence data may be adjusted according to the type of data for which the business intelligence data is being generated. For example, enterprise operational distribution, supply chain operational distribution, manufacturing operational distribution may be analyzed by the data analytics system 102 instead of research and developmental operational distribution.

In an additional embodiment, the data analytics system and the data visualization software 112 may run independently offline without the network 110 to facilitate the convenience of the user when network 110 is temporarily not available.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems (e.g., one or more systems) or a set of devices (e.g., one or more devices) of the environment 100 may perform one or more functions described as being performed by another set of systems or another set of devices of the environment 100.

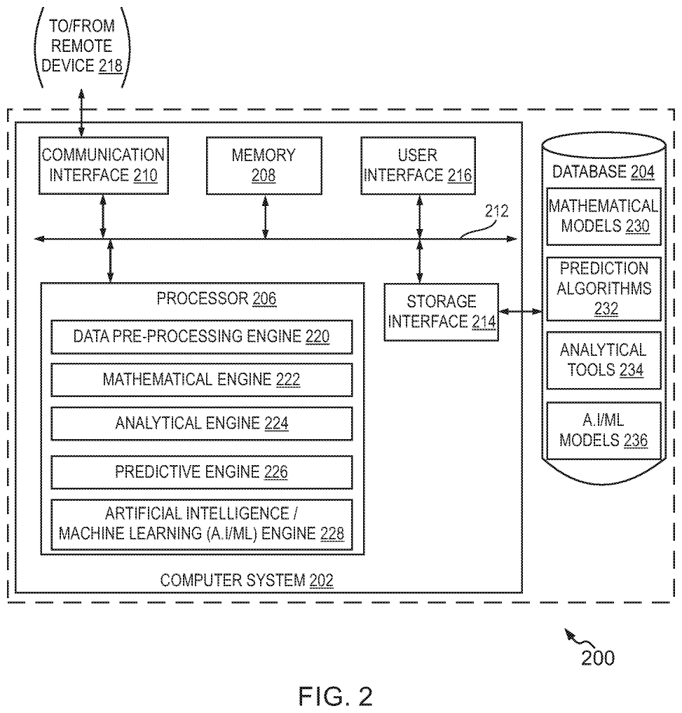

FIG. 2 is an exemplary block diagram of a data analytics system 200, in accordance with an embodiment of the present disclosure. The data analytics system 200 is similar to the data analytics system 102. In some embodiments, the data analytics system 200 is embodied as a cloud-based server system and/or SaaS-based (software as a service) architecture. The data analytics system 200 is configured to digitally transform the research and developmental data of a company or an organization to generate business intelligence data such as R&D efficiency, R&D productivity, unit ROI on the research and developmental investment, etc.

The data analytics system 200 includes a computer system 202 and a database 204. The computer system 202 includes at least one processor software 206 (interchangeably referred to as “processor 206” throughout the description) for executing instructions, a memory 208, a communication interface 210, and a user interface 216 that communicate with each other via a bus 212.

In some embodiments, the database 204 is integrated within computer system 202. For example, the computer system 202 may include one or more hard disk drives as the database 204. A storage interface 214 is any component capable of providing the processor software 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor software 206 with access to the database 204. In one embodiment, the database 204 is configured to incorporate mathematical models 230, prediction algorithms 232, analytical tools 234, and artificial intelligence/machine learning (AI/ML) models 236.

Examples of the processor associated with the processor software 206 include, but are not limited to, an application-specific integrated circuit (ASIC) processor, a reduced instruction set computing (RISC) processor, a complex instruction set computing (CISC) processor, a field-programmable gate array (FPGA), and the like. The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the data analytics system 200, as described herein. In another embodiment, the memory 208 may be realized in the form of a database server or cloud storage working in conjunction with the data analytics system 200, without departing from the scope of the present disclosure.

The processor software 206 is operatively coupled to the communication interface 210 such that the processor software 206 is capable of communicating with a remote device 218 such as, user device 108, or communicate with any entity connected to the network 110 (as shown in FIG. 1). Further, the processor software 206 is operatively coupled to the user interface 216 for interacting with the user device 108 to facilitate real-time visualization of business intelligence data generated from the research and developmental data accessed by the data analytics system 102.

It is noted that the data analytics system 200 as illustrated and hereinafter described is merely illustrative of an apparatus that could benefit from embodiments of the present disclosure and, therefore, should not be taken to limit the scope of the present disclosure. It is noted that the data analytics system 200 may include fewer or more components than those depicted in FIG. 2.

In one embodiment, the processor software 206 includes a data pre-processing engine 220, a mathematical engine 222, an analytical engine 224, a predictive engine 226, and an AI/machine learning (ML) engine 228. It should be noted that the components, described herein, can be configured in a variety of ways, including electronic circuitries, digital arithmetic and logic blocks, and memory systems in combination with software, firmware, and embedded technologies. The processor software 206 also processes the input data using mathematical models 230, prediction algorithms 232, analytical tools 234 and AI/ML models 236 to facilitate the data digital transformation.

The data pre-processing engine 220 includes suitable logic, circuitry, and/or interfaces to execute computer-readable instructions for accessing research and developmental data from a data source such as the data source 106 as described in FIG. 1 and converting the accessed data into machine-understandable format. The data pre-processing engine 220 may utilize one or more data pre-processing techniques available in the art to transform the research and developmental data into a machine-understandable format. In one embodiment, the research and developmental data accessed from the data source 106 may be raw data including random attributes and values. The data pre-processing engine 220 is configured to clean, transform, and reduce the research and developmental data such that the converted research and developmental data may be fed as inputs to the models such as the mathematical models, AI/ML models, and the like.

In one embodiment, the data pre-processing engine 220 may access the research and developmental data from one or more data sources associated with a company. External data such as voice of customer, voice of the market, supply chain data, enterprise data, etc., may also be accessed by the data pre-processing engine 220. The data accessed and converted by the data pre-processing engine 220 may further be used to generate business intelligence data.

The mathematical engine 222 includes suitable logic, circuitry, and/or interfaces to execute computer-readable instructions to analyze the research and developmental data to obtain operational distribution of risk, uncertainties, and resource demand The mathematical engine 222 utilizes the mathematical models 230 stored in the database 204 for analyzing the research and developmental data. The mathematical models may include a series of mathematical equations that transforms random and scattered research and developmental data into business intelligence data.

The mathematical equations utilized by the mathematical engine 222 may include:

$$R = f ( O , FTEs , {x}_{1} , {x}_{2} , {x}_{3} … ) \qquad eq . 1$$

$$R = a \cdot O + b \qquad eq . 2$$

$$R = s \cdot FTEs \qquad eq . 3$$

$$P = f ( O , FTEs , {y}_{1} , {y}_{2} , {y}_{3} … ) \qquad eq . 4$$

$$P = c \cdot {e}^{[ - d . ( O - g ) ]} ( 0 \leq P \leq 100 \% ) \qquad eq . 5$$

$$r = {r}_{1} . {r}_{2} . {r}_{3} . {r}_{4} . {r}_{5} . {r}_{6} … {r}_{11} \qquad eq . 6$$

$$r = 1 - P \qquad eq . 7$$

$$Unit ROI = \sum [ \frac{O \times P}{FTEs} \times ∅ n ] \qquad eq . 8$$

$$η = average ( {η}_{1} , {η}_{2} , {η}_{3} , {η}_{4} , {η}_{5} … {η}_{n} ) \qquad eq . 9$$

$$Distribution \% = \frac{{Mean}_{i}}{{\sum }_{i} {Mean}_{i}} \times 100 \% \qquad eq . 10$$

$$STDEV \% = \frac{STDEV}{Mean} \times 100 \% \qquad eq . 11$$

$$T = {\sum }_{t} {( Unit ROI )}_{i} \qquad eq . 12$$

$$ROI = D - S \qquad eq . 13$$

$$M = O \times P ( 0 \leq P \leq 1 ) \qquad eq . 14$$

$${C}_{i} = {B}_{i} \times ( 1 - {r}_{i} ) ( 0 \leq {r}_{i} \leq 1 ) \qquad eq . 15$$

$${C}_{3} = {B}_{1} . {CR}_{1} = {B}_{1} . ( 1 - {r}_{1} ) \qquad eq . 16$$

$${C}_{3} = {B}_{1} . {CR}_{1} . {CR}_{2} = {B}_{1} . ( 1 - {r}_{1} ) . ( 1 - {r}_{2} ) \qquad eq . 17$$

$${R}_{e 1} = \frac{Number of R \& D staff / Yr ( A )}{Number of new product launch / Yr ( C )} \qquad eq . 18$$

$${R}_{e 2} = \frac{New product sales / Yr ( D )}{Number of R \& D staff / Yr ( A )} \qquad eq . 19$$

$${R}_{e 3} = \frac{New product sales / Yr ( D )}{R \& D Spending / Yr ( B )} \qquad eq . 20$$

$${R}_{e 4} = \frac{R \& D Spending / Yr ( B )}{Number of new product launch / Yr ( C )} \qquad eq . 21$$

$${R}_{e 5} = \frac{New product sales / Yr ( D )}{Number of new product launch / Yr ( C )} \qquad eq . 22$$

The variable nomenclature of the equations 1-22 shown above are as follows: R—resource demand, O—opportunity size, FTE—Full-time employee, x1, x2, x3—factors affecting resource demand, a—resource coefficient, b—minimum initial resource required, s—resource scaling factor, P—probability of success, y1, y2, y3—other factors affecting probability of success, c—probability of success for smallest opportunity, d—risk sensitivity coefficient, g—initial opportunity size, r—risk of failure, r1, r2, r3, r4, r5, r6, . . . r11—risk of failure for each operational segment, Unit ROI—unit return on investment, ROI—return on investment, ϕn—percentage of new product in portfolio,—operational efficiency, η1, η2, η3, η4, η5, . . . ηn—operational efficiency of each operational unit, Distribution %—percentage of distribution, Mean—statistical average, Mean—statistical average of the random variable, STDEV—standard deviation, STDEV %—percentage of standard deviation, T—total new product sales, D—total market demand in product and services, S—total spending as investment, M—marketing forecast opportunity size, Ci—total number of cascading products at size i, Bi—base number of new products at size i, ri—risk of failure at size i, C2—total number of cascading products at size 2, B 1- base number of new products at size 1, CR1—cascading ratio from size 1 to size 2, C3—total number of cascading products at size 3, CR2—cascading ratio from size 2 to size 3, Re1—statistical average number of R&D staff per product launched, Re2—statistical average new product sales per R&D staff, Re3—statistical average new product sales per dollar R&D spending, Re4—statistical average R&D spending per new product launch, Re5—statistical average new product sales per new product launch.

The mathematical engine 222 includes rules that are used to input to the mathematical models to determine the operational distribution of risk, uncertainties, and resource demand The rules may be one or a combination of resource distribution vs. opportunity size, probability and risk distribution vs. opportunity size, and market equilibrium. The mathematical engine 222 with the help of the formulae stored in the mathematical models 230 as shown above is configured to present the relationship between the input and output variables. The relationship between the inputs and outputs is defined by the mathematical equations and functions included in the equations 1-22. The mathematical engine 222 is configured to determine operational distributions using the equations and the relationships between the inputs that are fed and the outputs that are desired from the mathematical engine 222.

The mathematical engine 222 takes input random variables selected from new product size, new opportunity forecast size, R&D resource scaling factor, R&D resource coefficient, minimum initial R&D resource required, probability of success for the smallest new product, and risk sensitivity coefficient, of combination thereof. The mathematical engine 222 generates at least one output random variable selected from R&D efficiency (Rₑ₁), R&D productivity (Rₑ₂), and unit return on R&D investment (Unit ROI) or a combination thereof.

The R&D efficiency is defined as a resource in the number of R&D staff per year needed to launch one new product in a year as per following expression:

$${R}_{e 1} = \frac{Number of R \& D staff / Yr ( A )}{Number of new product launch / Yr ( C )} \qquad ( eq . 18 )$$

The R&D productivity is defined as output in new product sales per year by one full-time employee (FTE) in a year as per the following expression:

$${R}_{e 2} = \frac{New product sales / Yr ( D )}{Number of R \& D staff / Yr ( A )} \qquad ( eq . 19 )$$

As provided in Equation (8), ROI is defined as the total sum of all new products in their opportunity size O, probability of success P, total FTEs needed to develop the new product, and the percentage of the project in the product portfolio, Φn.

$$Unit ROI = \sum [ \frac{O \times P}{FTEs} \times ∅ n ] \qquad ( eq . 8 )$$

The analytical engine 224 includes suitable logic, circuitry, and/or interfaces to execute computer-readable instructions to quantify the unit return on investment based on the research and developmental investment and operational deficiency. The analytical engine 224 takes inputs selected from new product size, new opportunity forecast size, number of new opportunities, year, quarter, R&D resource demand coefficient, minimum R&D resource required, initiation probability of success, risk sensitivity coefficient, or combination thereof. This data is readily available on company data servers and financial, operational, and R&D reports. The data servers are commercially available from suppliers and the software of the analytical engine 224 can be written with commercially available coding software from various platforms such as Python, C++, C+, C, Java, JavaScript, LISP, Prolog, R, S, or combination thereof.

The analytical engine 224 of the present invention takes these random and scattered R&D data and utilizes the mathematical models 230 to generate the outputs that include R&D efficiency, R&D productivity, return on R&D investment, and unit return on investment (ROI). The R&D efficiency, R&D productivity, and unit return on investment (ROI) are generated using the equations eq.1-8, eq.18, eq.19, eq.20, eq.21, and eq.22 in combination. The variables A, B, C, and D in the equations are used to plot various two-dimensional graphs by quantifying the unit return on investment (ROI) based on research and developmental investment and operational deficiency.

The analytical engine 224 is further configured to transform the research and developmental data for visualization, optimization and distribution mapping of efficiency, productivity and cost. The analytical engine 224 is configured to utilize analytical tools 234 embedded in the database 204 for transforming the research and developmental data for visualization, optimization and distribution mapping of efficiency, productivity, and cost.

In one embodiment, the analytical tools 234 have inputs selected from time, individual new product annual sales, a statistical average of annual sales per new product, year, new product launches, total number of R&D staff, resource demand per new product, statistical average resource demand for each new product, R&D spending, product category or combination thereof. The analytical tools 234 have outputs selected from statistical average new product sales, statistical average new product sales per R&D staff, return on R&D investment, expected return on R&D investment, unit sales return on R&D investment (Unit ROI), statistical average forecast opportunity size per new product, distribution of probability of success, distribution of risk and uncertainties, statistical average forecast new product sales, statistical average new product sales, year-over-year organic growth distribution, or combination thereof.

The predictive engine 226 includes suitable logic, circuitry, and/or interfaces to execute computer-readable instructions to forecast emerging product opportunities and future new product sales using the prediction algorithms 232 embedded in the database 204. The prediction algorithms 232 may include one or more prediction techniques that are based on the mathematical models 230 (eq.13-eq.17) for forecasting future values of a certain attribute. For example, a statistical prediction model that is created and adjusted to predict future outcomes may also be included in the prediction algorithms 232 and utilized by the predictive engine 226 for forecasting emerging product opportunities and future new product sales.

In one embodiment, the predictive engine 226 may provide one or a combination of voice of market, voice of customer, marketing forecast, financial target, macroeconomic condition, competitions, sales, marketing & technology service, number of new products launched, sales of each new product launched as input to the predictive algorithms 232. The predictive algorithms 232 may output one or a combination of new product sales forecast, R&D productivity forecast, R&D efficiency forecast, and risk and uncertainty distribution forecast based on the input provided to the predictive algorithms 232.

The AI/ML engine 228 includes suitable logic, circuitry, and/or interfaces to execute computer-readable instructions to facilitate visualization of business intelligence data in real-time on a user device such as the user device 108 as described in FIG. 1. The AI/ML engine 228 may utilize the AI/ML models 236 embedded in the database 204 for continuously improving the visualization of business intelligence data including productivity, efficiency, unit return on investment, risk and uncertainty distribution, new product sale forecast, future opportunity mapping, portfolio optimization, and optimum resource allocation. The AI/ML models 236 may be trained beforehand or use continuously iterative data stream to generate improved and more accurate visualizations based on the research and developmental data provided as input to the AI/ML models 236.

In one embodiment, the mathematical models 230 and prediction algorithms 232 may be utilized by the AI/ML engine 228 along with the AI/ML models 236. These models may be programmed into different computer languages and provided to the data analytics system 200 to enable the AI/ML engine 228 for analyzing, understanding, and optimizing the research and developmental data in a short span of time. The program language can be selected from commercially available Python, C++, C+, C, Java, JavaScript, LISP, Prolog, R, S, or combination thereof.

In one embodiment, the inputs for the AI/ML engine 228 are selected from financial targets, R&D data, new opportunities, and market forecast. These data are accessed from the data source such as the data source 106 and/or from the data output from the mathematical engine 222, and predictive engine 226. The outputs of the AI/ML engine 228 are analyzed in real-time and presented in a visualized format via the graphical user interface of the remote device 218 such as the user device 108. The outputs may also be visualized on remote devices such as cloud, desktop, mobile terminal, etc.

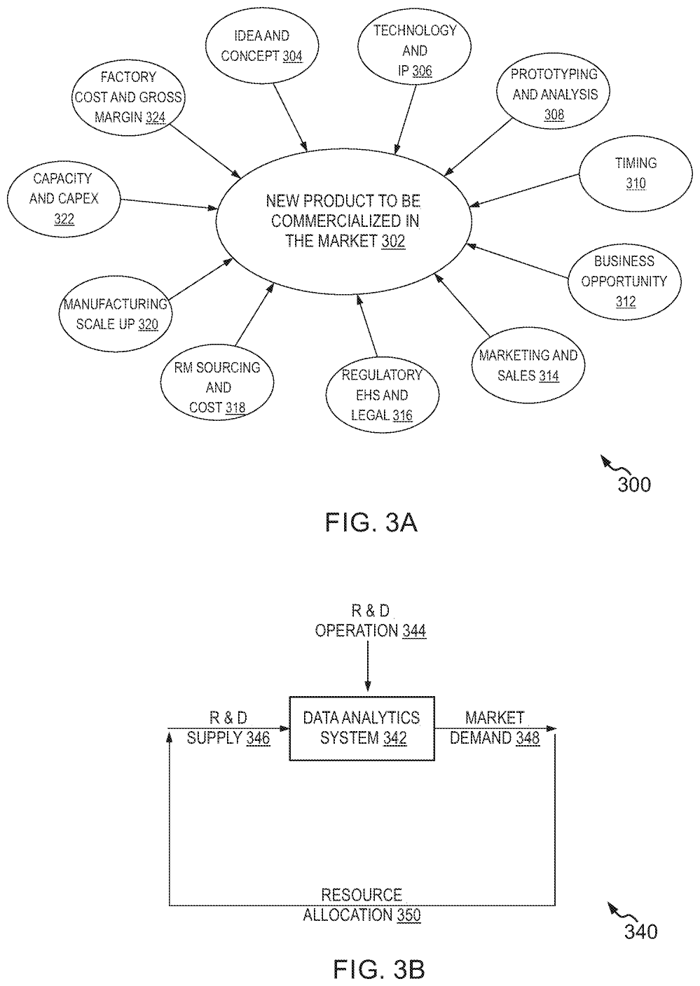

FIG. 3A is a representation 300 of some of the possible risks and uncertainties in the R&D of a new product, in accordance with an embodiment of the present disclosure. The block 302 represents a new product to be commercialized in the market. The blocks 304-324 represent different risks and uncertainties that may affect the R&D of the new product to be commercialized in the market.

In one embodiment, the risk and uncertainties may include idea and concept 304, technology and intellectual property 306, prototyping and analysis 308, timing 310, business opportunity 312, marketing and sales 314, regulatory EHS (environmental, health, safety) and legal 316, raw material (RM) sourcing and cost 318, manufacturing scale-up 320, capacity and CapEx 322, and factory cost and gross margin 324. The above-listed risk and uncertainties are shown only for exemplary purposes and in no way limit the scope of the invention.

FIG. 3B is a block diagram representation 340 of how the data analytics system 342 is used to optimize enterprise resource planning (ERP), in accordance with an embodiment of the present disclosure. The data analytics system 342 may be similar to the data analytics system 200 as described in FIG. 2. The data analytics system 342 analyzes the R&D operation 344 and digitally transform the R&D data inputs such as R&D Supply 346 in resource spending and allocation of full time employees on a given product portfolio into various outputs related to market demand 348 in the forms of new product sales for a given company. The data analytics system 200 becomes the core engine for the digital transformation for R&D operation 344 to provide useful business intelligence data as specific outputs in some embodiments. The role of the digital transformation using the data analytics system 342 is to achieve the maximization of market demand 348 in the form of new product sales for a given company.

In one embodiment, the R&D supply 346 may include data such as spending related to R&D operation 344 including yearly spending, total R&D spending, R&D investment, Capital Expenditure, and the like. The R&D supply data may also include a number of full-time employees (ETFs) working on R&D operation 344, number of new product launches, and the spending made on the ETFs. The market demand 348 (in the form of new product sales) may include data such as future new product sales, ROI on research, and R&D efficiency and productivity. The resource allocation 350 is distributed on a regular R&D cycle based on the market demand that is optimized by the data analytics system 342. The R&D supply 346 may be optimized based on the maximized market demand output, optimized by the data analytics system 342.

In another embodiment, the data analytics system 200 is used in an Enterprise Resource Planning platform (ERP) for optimizing R&D operations based on R&D data inputs.

In another embodiment, the processor software 206 in data analytics system 200 is used in a Digital Twin to digitally represent the entire R&D operation so digital simulations on the R&D operation 350 are carried out to maximize the market demand output 346 in the form of new product sales. The Digital Twin in this case has its roots in economic and operational theories, mathematical modeling and data analytics on R&D efficiency, productivity and system-level risk and opportunity distributions contributing to a realistic digital representation specifically for a complex R&D ecosystem, such as the processor software 206 in data analytics system 200. The processor software 206 in data analytics system 200 instantly predicts the various financial and operational outcomes based on proprietary algorithms for different R&D investment strategies from essential business operational input parameters using a system level design surrounding the complex inter-connectivity of R&D components and sub-components. Due to its digital nature, the processor software 206 in data analytics system 200 is free of risk from repeated exploration, optimization and continuous iterations until a best operational strategy for maximum return on R&D investment on a balance of limited R&D investment is identified. In the conventional systems, due to the inter-connected sub-components within R&D ecosystem, a similar kind of complex learning curve generally takes months and years of concentrated efforts to obtain, analyze and infer from scattered R&D data inputs, mostly through trial and error approach on the one and only real and physical R&D ecosystem. If such limitation of conventional systems is not optimized, it could cost the company up to millions and/or billions of dollars while the feedback could be extremely slow and the results are often inconclusive.

The processor software 206 in data analytics system 200, on the other hand, avoids most of these huge operational and opportunity costs by grounding itself on solid theoretical framework and accurate mathematical modeling, effectively assisting decision makers to obtain instant insights and expose potential impact(s) on their critical decisions.

In an additional embodiment, the data analytics system 342 may be used as an Enterprise Strategic Planning (ESP) platform to optimize strategic planning process flow. Traditionally, the enterprise strategic planning process is a bottom up process where each individual business group comes up its own operational plan and feed upwards throughout the enterprise organization. This process is quite time consuming and full of inconsistency and non-uniformity across different businesses and divisions. The data analytics system 342 may be used as an Enterprise Strategic Planning(ESP) platform to optimize the entire strategic planning process flow through a top-down process flow aided by the data analytics systems 342. This process may be carried out companywide, business group level, and/or division level throughout the enterprise. The company executives may first set the financial goal and targets for the entire company. The data analytics system 342 may digitally transform the financial goal and targets into operational targets across the entire enterprise organization down to business groups and divisions with evenly and uniformly distributed operational targets. The operational targets may be aligned toward a common centralized financial target.

In another embodiment, the data analytics system 342 is used to digitally transform the research and developmental data collected from a customer relationship management (CRM) software of a company. The commercially available CRM software example may be Salesforce.com in one example embodiment.

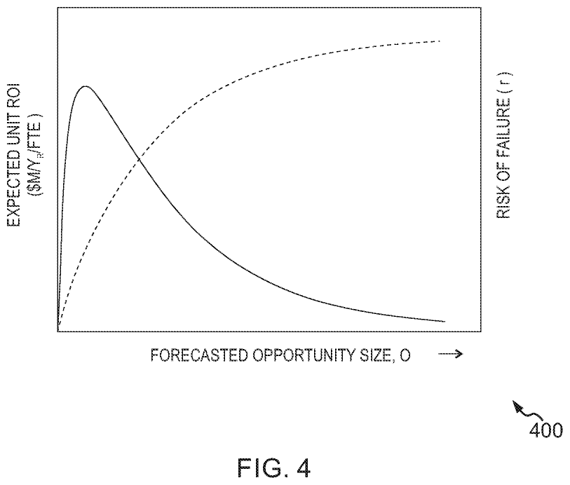

FIG. 4 is a two-dimensional (2D) graph 400 representing a graph plotted for unit return on investment (ROI) distribution vs. forecasted opportunity size, in accordance with an example embodiment of the present disclosure. The 2D graph 400 may be generated by the mathematical engine 222. The 2D graph 400 is plotted for unit ROI distribution vs. forecasted opportunity size. The values on the x-axis include forecasted opportunity size and the values on the y-axis include expected unit ROI and risk of failure.

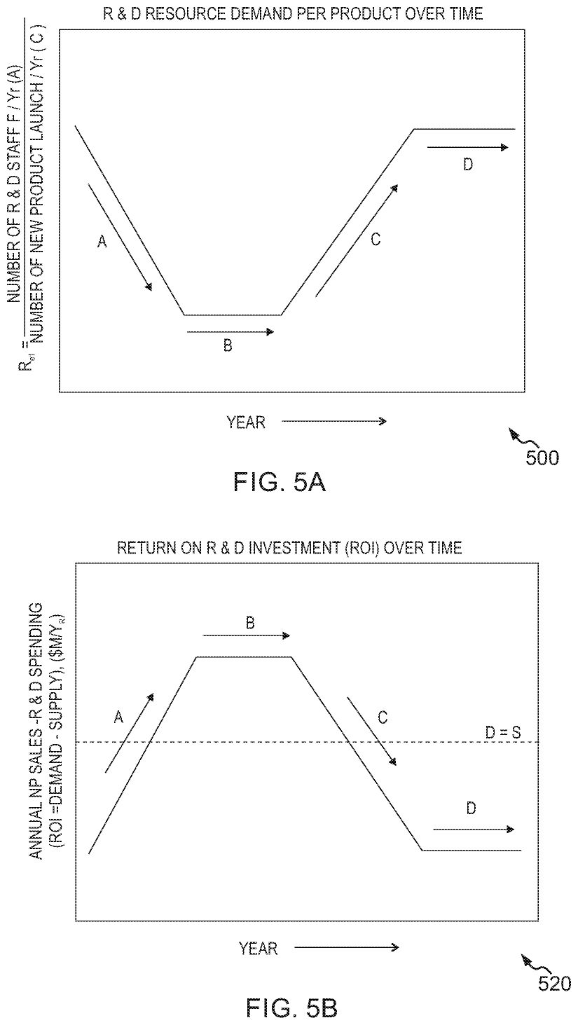

FIGS. 5A and 5B are two-dimensional (2D) graphs 500 and 520 respectively that are output by the analytical engine 224 of the data analytics system 200, in accordance with an embodiment of the present disclosure. The graphs shown in the FIGS. SA and 5B may be output by the analytical engine 224 based on the quantification of the unit ROI. The unit ROI may be determined using the research and developmental investment and the operational deficiency. The graphs may be generated by utilizing the formulae stored in the mathematical models 230 as described in FIG. 2.

The 2D graph 500 depicts a graph plotted for the R&D resource demand per product over time. The R&D resource demand is plotted along the y axis and the time is plotted along the x-axis. The R&D resource demand is denoted by the equation eq. 21,

$${R}_{e 1} = \frac{Number of R \& D Staff / Yr ( A )}{Number of new product launch / Yr ( C )} ,$$

and the time is denoted by year along the x-axis of the 2D graph 500. The 4 distinctively different exemplary stages of A, B, C, D illustrate examples of critical business intelligence as related to R&D productivity needed for effective decisions in enterprise resource allocation for maximizing return on R&D investment.

The 2D graph 520 depicts a graph plotted for the return on R&D investment (ROI) over time. The ROI is plotted along the y-axis and the time is plotted along the x-axis. The ROI is defined as the difference between the annual new product sales and the R&D spending, and the time is denoted by year along the x-axis of the 2D graph 520. The ROI may also be simplified as the difference between the market demand and R&D supply. A dotted line is plotted in the graph where the demand is equal to supply (D=S). The 4 distinctively different exemplary stages of A, B, C, D illustrate examples of critical business intelligence on return on investment as related to R&D operations needed for effective decisions in enterprise resource allocation for maximizing ROI in long-term horizon.

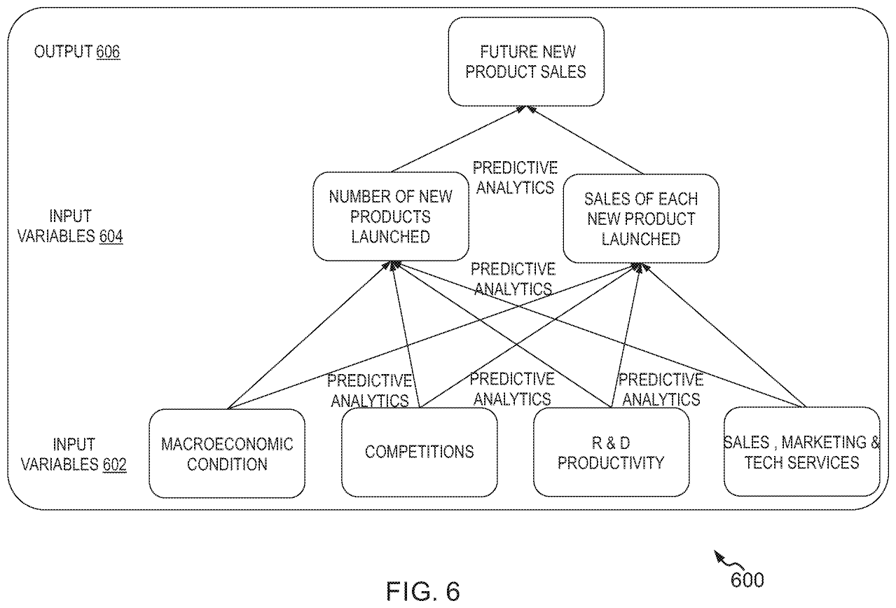

FIG. 6 is a flow diagram 600 for forecasting new product sales by the predictive engine 226 of the data analytics system 200, in accordance with an embodiment of the present disclosure. The predictive engine 226 may utilize the prediction algorithms 232 can be utilized for forecasting future new product sales or emerging product opportunities. The flow diagram 600 is exemplarily shown to forecast future new product sales by the predictive engine 226 by utilizing the analytical tools 234 as described in FIG. 2.

The predictive engine 226 may input one or more variables (see, 602 and 604) to the prediction algorithms 232 for forecasting the future new product sales. The prediction algorithms may include one or more prediction techniques that incorporate the mathematical equations stored in the mathematical models 230 for forecasting future values of a certain attributes. For example, a statistical prediction model that is created and adjusted to predict future outcomes included in the prediction algorithms 232 and mathematical equations in the mathematical models 230 may be utilized by the predictive engine 226 for forecasting future new product sales in the embodiment.

The input variables may include voice of market, voice of customer, marketing forecast, financial target, macroeconomic condition, competitions, sales, marketing & technology service, number of new products launched, sales of each new product launched, or combination thereof. Some of the inputs are shown to be exemplarily fed to the predictive algorithms for performing predictive analysis. The output (see, 606) of the predictive analysis for the input variables fed at 602 and 604 is shown to be future new product sales.

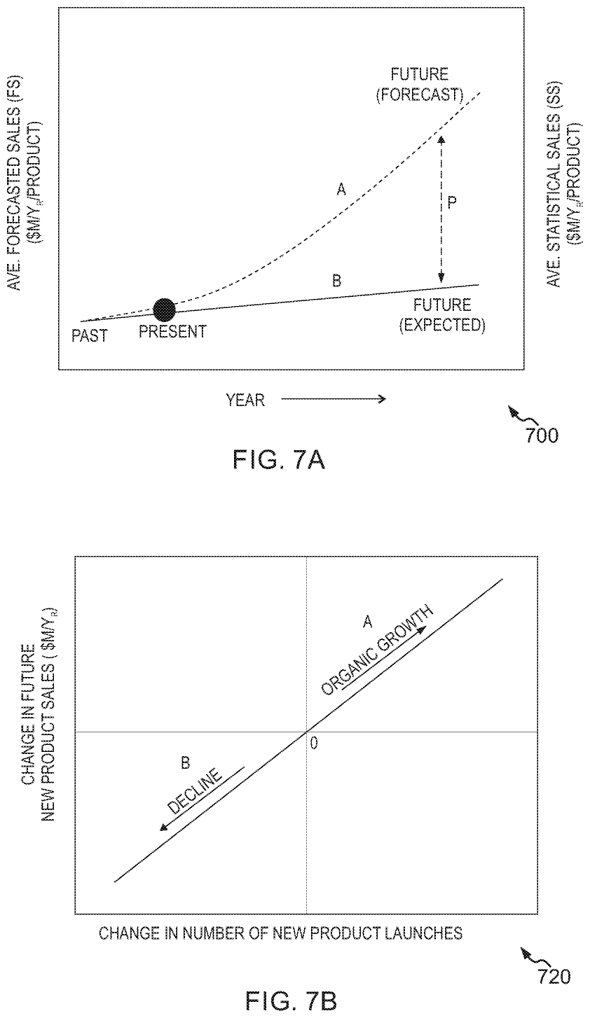

FIGS. 7A and 7B are two-dimensional graphs 700 and 720 respectively that are output by the predictive engine 226 of the data analytics system 200, in accordance with an embodiment of the present disclosure. The graphs shown in the FIGS. 7A and 7B may be exemplary outputs by the predictive engine 226 based on the prediction analytics performed to correlate traditional forecast on emerging product opportunities and future new product sales in order to surface the critical business intelligence signal related to probability of success, P. The graphs may be generated by utilizing the mathematical models 230 as described in FIG. 2.

In one embodiment, the 2D graph 700 depicts a graph plotted for the forecast opportunity size vs. expected sales. The average forecasted sales and the average statistical sales are plotted along the y-axis and the time is plotted along the x-axis. The 2D graph 700 includes past, present, and future values of forecasted values and expected values. The dotted line ‘A’ represents the forecasted sales and the line ‘B’ represents the expected sales. P represents the probability distribution.

The 2D graph 720 depicts a graph plotted for forecasted future new product sales vs. new product launches. The change in future new product sales is plotted along the y axis and the change in the number of new product launches is plotted along the x-axis. The graph passes through the origin (0, 0) coordinate and ‘A’ represents organic growth and ‘B’ represents decline.

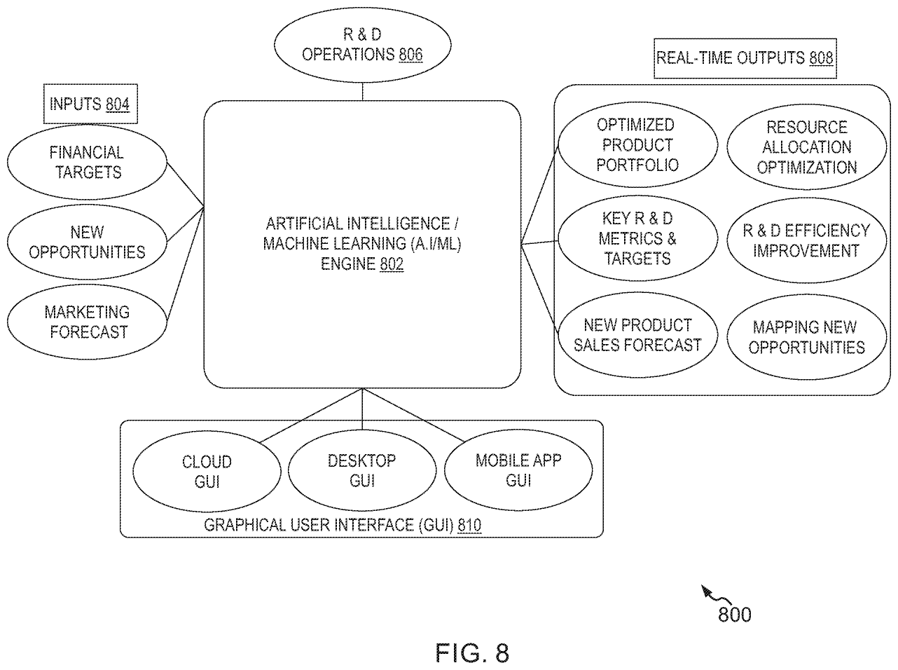

FIG. 8 is an exemplary block diagram 800 of an AI/machine learning (ML) engine 802, in accordance with an embodiment of the present disclosure. The AI/ML engine 802 may be similar to the AI/ML engine 228 of the data analytics system 200 as described in FIG. 2. The AI/ML engine 802 may be fed with inputs 804 for a specific R&D operations 806. The R&D operations 806 may encounter unknown risk and uncertainties that are part of the system characteristics. The exemplary risk and uncertainties for a new product being launched are explained in detail in FIG. 3A. The AI/ML engine 802 may provide real-time digital transformation from inputs 804 to various business intelligence outputs 808 by utilizing one or more AI/machine learning models such as the AI/ML models 236 as described in FIG. 2.

In one embodiment, the AI/ML models may include one or a combination of Convolutional Neural Networks (CNNs), Recurrent Neural Networks (RNNs), single and multi-variable regression models, classification models, clustering models, patterning models, anomaly detection models, and Deep Learning Neural Network (DLNN) models.

The AI/ML engine 802 may further facilitate the visualization of the real-time outputs 808 on the graphical user interface (GUI) 810 of one or more user devices. The user devices include a plurality of electronic devices installed with the R&D data application 112 as described in FIG. 1. The real-time outputs 808 may include business intelligence data such as graphs, dashboards, forecast results, and the like.

In one embodiment, the inputs 804 may include financial targets, new opportunities, new opportunities, marketing forecast, and other research and developmental data described in the description previously. The R&D operations may include the risk and uncertainties as described in detail in FIG. 3A. The AI/ML engine 802 is configured to utilize AI/ML models 236 that are trained for generating one or more real-time outputs for visualization. The real-time outputs 808 may include optimized product portfolio, resource allocation optimization, business metrics and financial targets, R&D efficiency improvement, new product sales forecast, and mapping new opportunities. The AI/ML engine 802 is configured to generate real-time visualization of the business intelligence data included in the real-time outputs 808.

In an additional embodiment, the AI/ML engine 802 is also configured to take the inputs of voice of customer, voice of market, marketing forecast, financial target, and other research and developmental data. These inputs may be processed using the AI/ML models to generate real-time visualization of the data as described above.

Particularly, the data analytics system 200 as described in FIG. 2 takes in one or more variables form the inputs 804 and feeds them through the AI/machine learning engine 802, including business intelligence and real-time digital transformation capabilities. The data analytics system 200 further provides one or more outputs 808 including optimized product portfolio, resource allocation optimization, R&D efficiency and productivity optimization, new product sales forecast, and mapping new product opportunities.

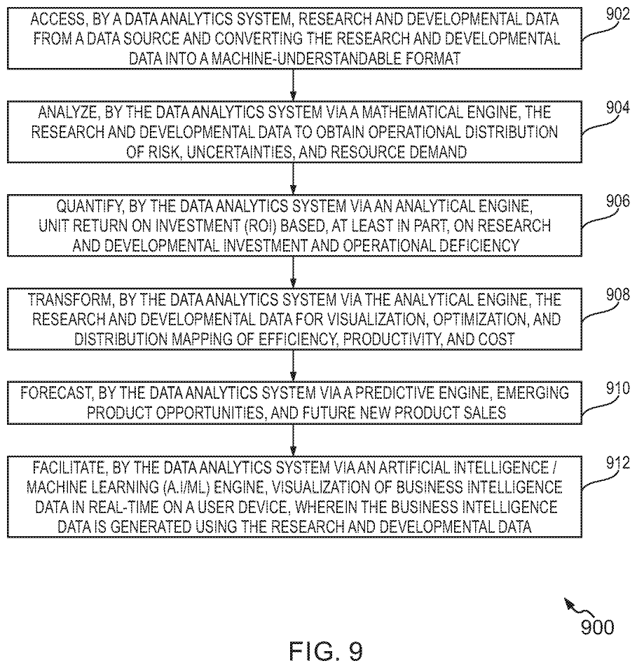

FIG. 9 is a flow diagram of a computer-implemented method 900 for digitally transforming research and developmental data for generating business intelligence data, in accordance with an embodiment of the present disclosure. The method 900 depicted in the flow diagram may be executed by, for example, at least one data analytics system such as the data analytics system 102. Operations of the flow diagram of method 900, and combinations of operation in the flow diagram of method 900 may be implemented by, for example, hardware, firmware, a processor, circuitry, and/or a different device associated with the execution of software that includes one or more computer programmable languages selected from Python, C++, C+, C, Java, JavaScript, LISP, Prolog, R, S, or combination thereof. The method 900 starts at operation 902.

At the operation 902, the method 900 includes accessing research and developmental data from a data source such as the data source 106 and converting the research and developmental data into machine-understandable format. The conversion may be performed using data pre-processing techniques.

At the operation 904, the method 900 includes analyzing the research and developmental data to obtain operational distribution of risk, uncertainties, and resource demand, via a mathematical engine such as the mathematical engine 222 of the data analytics system 200 as described in FIG. 2.

At the operation 906, the method 900 includes quantifying unit return on investment (ROI) based, at least in part, on research and developmental investment and operational deficiency, via an analytical engine such as the analytical engine 224 of the data analytics system 200 as described in FIG. 2.

At the operation 908, the method 900 includes transforming research and developmental data for visualization, optimization, and distribution mapping of efficiency, productivity, and cost, via the analytical engine 224 of the data analytics system 200 as described in FIG. 2.

At the operation 910, the method 900 includes analyzing the research and developmental data to obtain operational distribution of risk, uncertainties, and resource demand, via a mathematical engine such as the mathematical engine 222 of the data analytics system 200 as described in FIG. 2.

At the operation 912, the method 900 includes facilitating visualization of business intelligence data in real-time on a user device such as the user device 108. The business intelligence data may be generated using the research and developmental data. The visualization may be facilitated via an AI/machine learning (ML) engine such as the AI/ML engine 228 of the data analytics system 200 as described in FIG. 2.

The sequence of operations of the method 900 need not be necessarily executed in the same order as they are presented. Further, one or more operations may be grouped and performed in form of a single step, or one operation may have several sub-steps that may be performed in parallel or a sequential manner

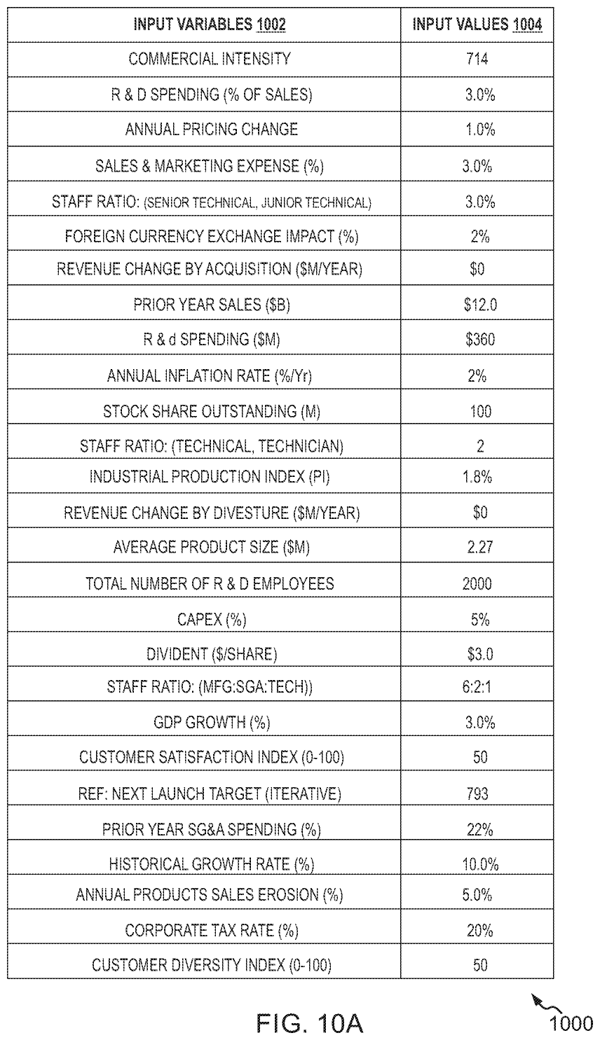

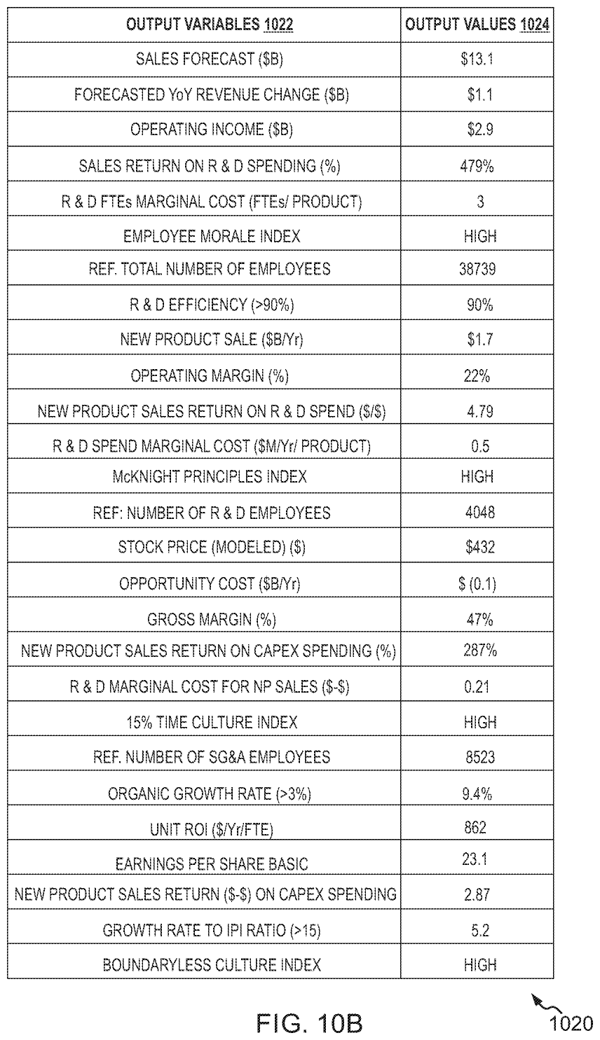

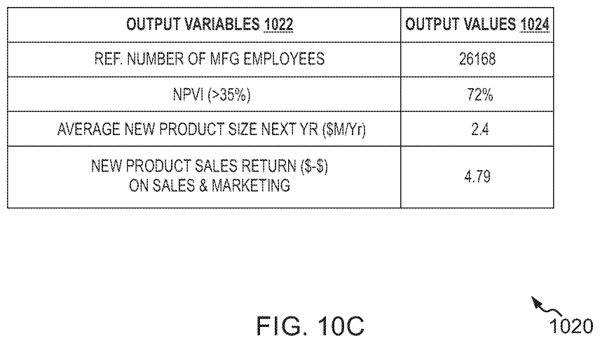

FIGS. 10A-10C are exemplary tabular representations of input and output variables of the data analytics system 200, as part of a Digital Twin, in accordance with an embodiment of the present disclosure. The input and output variables shown in the FIGS. 10A and 10B are only for exemplary purposes and do not limit the scope of the invention. FIG. 10A is an exemplary tabular representation 1000 including a column named input variables 1002 and the corresponding values associated with the input variables 1002 in the column named input values 1004. The input variables may be one of commercial intensity, R&D spending expressed in percentage (%) of sales, annual pricing change, sales & marketing expense expressed in %, staff ratio expressed as ratio between senior technical and junior technical staffs, foreign currency exchange impact expressed in %, revenue change by acquisition expressed as currency in million per year (Sm/year), prior year sales expressed as currency in billion (Sb), R&D spending expressed as currency in million (Sm), annual inflation rate expressed as percentage per year (%/year), stock share outstanding (m), staff ratio: (technical, technician), industrial production index (Pi), revenue change by divesture (Sm/year), average product size (Sm), total #of r & d employees, capex (%), dividend (S/share), staff ratio: (mfg:sga:tech), GDP growth (%), customer satisfaction index (0-100), ref: next launch target (iterative), prior year SG&A spending (%), historical growth rate (%), annual products sales erosion (%), corporate tax rate (%), customer diversity index (0-100).

The values corresponding to the input variables 1002 are exemplarily shown in the column input values 1004. The values may be expressed in their corresponding units such as percentage, money per year, and the like. The value for R&D spending may be 3.0%, annual pricing change may be 1.0%, prior year sales may be 12 billion dollars. Similarly each of the input variables may be provided with their corresponding values. These input values 1004 may be fetched from one or more data sources such as data source 106 as described in FIG. 1.

The data analytics system 200 is configured to take the input variables and their corresponding variables and perform various operations using mathematical engine 222, analytical engine 224, predictive engine 226, AI/ML engine 228, and the like as described in FIG. 2.

FIGS. 10B and 10C are exemplary tabular representations 1020 including a column named output variables 1022 and the corresponding values associated with the output variables 1024 in the column named output values 1024. The output variables may be one of sales forecast ($b), forecasted year over year (YOY) revenue change ($b), operating income ($b), sales return on R&D spending (%), R&D FTEs marginal cost (FTEs/product), employee morale index, ref. total number of employee, R&D efficiency (>90%), new product sale ($b/year), operating margin (%), new product sales return on R&D spend ($/$), R&D spend marginal cost ($m/year/product), Mcknight principles index, ref: number of R&D employees, stock price (modeled) ($), opportunity cost ($b/year), gross margin (%), new product sales return on capex spending (%), R&D marginal cost for new product sales ($-$), 15% time culture index, ref. number of SG&A employees, organic growth rate (>3%), unit ROI ($/year/FTE), earnings per share basic, new product sales return ($-$) on capex spending, growth rate to IPI ratio (>15), boundary less culture index, ref. number of manufacturing employees, NPVI (>35%), average new product size next year ($m/year), new product sales return ($-$) on sales & marketing.

The values corresponding to the output variables 1022 are exemplarily shown in the column input values 1024. The values may be expressed in their corresponding units such as percentage, money per year, and the like. The value for sales forecast may be 13.1 billion dollars, operating income may be 2.9 billion dollars, employee morale index may be high, operating margin may be 22%, etc. Similarly each of the output variables may be provided with their corresponding values. These output values 1024 may be derived from one of the mathematical engine 222, analytical engine 224, predictive engine 226, AI/ML engine 228, and the like as described in FIG. 2. The outputs may be determined by utilizing one or more engines for visualization, optimization, and the like of research and developmental data, manufacturing data, enterprise data, supply chain data, etc.

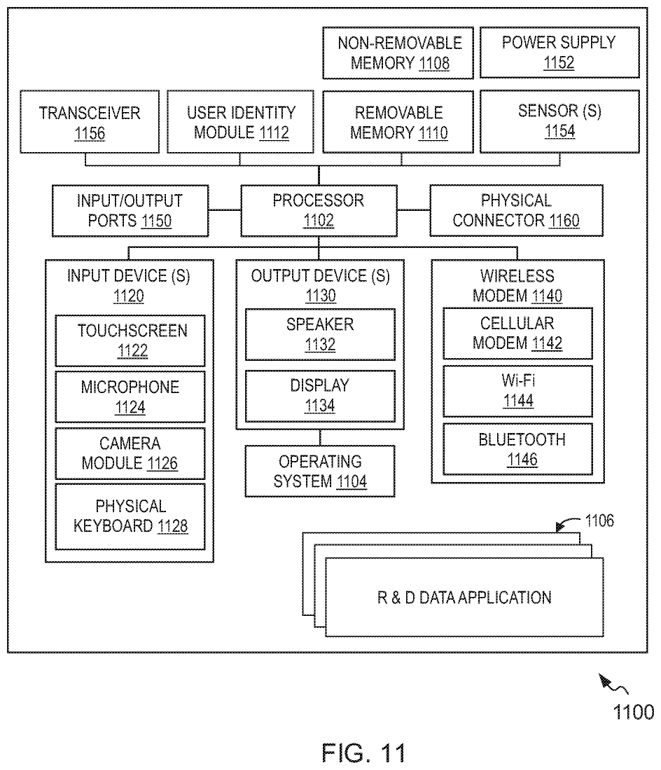

FIG. 11 shows an exemplary block diagram of an electronic device 1100 capable of implementing the various embodiments of the present disclosure. The electronic device 1100 may be an example of the user device 108 shown in FIG. 1. It should be understood that the electronic device 1100 as illustrated and hereinafter described is merely illustrative of one type of device and should not be taken to limit the scope of the embodiments. As such, it should be appreciated that at least some of the components described below in connection with the electronic device 1100 may be optional and thus in an example embodiment may include more, less, or different components than those described in connection with the example embodiment of the FIG. 11. As such, among other examples, the electronic device 1100 could be any of an electronic device or may be embodied in any of the electronic devices, for example, cellular phones, tablet computers, laptops, mobile computers, personal digital assistants (PDAs), mobile televisions, mobile digital assistants, or any combination of the aforementioned, and other types of communication or multimedia devices.

The illustrated electronic device 1100 includes a controller or a processor 1102 (e.g., a signal processor, microprocessor, ASIC, or other control and processing logic circuitry) for performing such tasks as signal coding, data processing, image processing, input/output processing, power control, and/or other functions. An operating system 1104 controls the allocation and usage of the components of the electronic device 1100 and provides support for one or more programs such as visualizing the business intelligence data received from the data analytics system 200. The electronic device 1100 is depicted to include one or more applications such as a R&D data application 1106 facilitated by the data analytics system 200. The R&D data application 1106 can be an instance of an application downloaded from the data analytics system 200 or a third-party server. The R&D data application 1106 is capable of communicating with the data analytics system 200 for facilitating real-time visualization of business intelligence data generated using the research and developmental data of a company. The applications may include common computing applications (e.g., telephony applications, email applications, calendars, contact managers, web browsers, messaging applications such as USSD messaging or SMS messaging or SIM Tool Kit (STK) application) or any other computing application.

The illustrated electronic device 1100 includes one or more memory components, for example, a non-removable memory 1108 and/or a removable memory 1110. The non-removable memory 1108 and/or the removable memory 1110 may be collectively known as storage device/module in an embodiment. The non-removable memory 1108 can include RAM, ROM, flash memory, a hard disk, or other well-known memory storage technologies. The removable memory 1110 can include flash memory, smart cards, or a Subscriber Identity Module (SIM). The one or more memory components can be used for storing data and/or code for running the operating system 1104. The electronic device 1100 may further include a user identity module (UIM) 1112. The UIM 1112 may be a memory device having a processor built-in. The UIM 1112 may include, for example, a subscriber identity module (SIM), a universal integrated circuit card (UICC), a universal subscriber identity module (USIM), a removable user identity module (R-UIM), or any other smart card. The UIM 1112 typically stores information elements related to a mobile subscriber. The UIM 1112 in form of the SIM card is well known in Global System for Mobile (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The electronic device 1100 can support one or more input devices 1120 and one or more output devices 1130. Examples of the input devices 1120 may include, but are not limited to, a touch screen/a display screen 1122 (e.g., capable of capturing finger tap inputs, finger gesture inputs, multi-finger tap inputs, multi-finger gesture inputs, or keystroke inputs from a virtual keyboard or keypad), a microphone 1124 (e.g., capable of capturing voice input), a camera module 1126 (e.g., capable of capturing still picture images and/or video images) and a physical keyboard 1128. Examples of the output devices 1130 may include, but are not limited to, a speaker 1132 and a display 1134. Other possible output devices can include piezoelectric or other haptic output devices. Some devices can serve more than one input/output function. For example, the touch screen 1122 and the display 1134 can be combined into a single input/output device.

A wireless modem 1140 can be coupled to one or more antennas (not shown in the FIG. 11) and can support two-way communications between the processor 1102 and external devices, as is well understood in the art. The wireless modem 1140 is shown generically and can include, for example, a cellular modem 1142 for communicating at long range with the mobile communication network, a Wi-Fi compatible modem 1144 for communicating at short range with an external Bluetooth-equipped device or a local wireless data network or router, and/or a Bluetooth-compatible modem 1146. The wireless modem 1140 is typically configured for communication with one or more cellular networks, such as a GSM network for data and voice communications within a single cellular network, between cellular networks, or between the electronic device 1100 and a public switched telephone network (PSTN).

The electronic device 1100 can further include one or more input/output ports 1150, a power supply 1152, one or more sensors 1154 for example, an accelerometer, a gyroscope, a compass, a global positioning system sensor (for providing location details) or an infrared proximity sensor for detecting the orientation or motion of the electronic device 1100, a transceiver 1156 (for wirelessly transmitting analog or digital signals) and/or a physical connector 1160, which can be a USB port, IEEE 1294 (FireWire) port, and/or RS-232 port. The illustrated components are not required or all-inclusive, as any of the components shown can be deleted and other components can be added.

The disclosed method with reference to FIG. 9, or one or more operations of the method 900 may be implemented using software including computer-executable instructions stored on one or more computer-readable media (e.g., non-transitory computer-readable media, such as one or more optical media discs, volatile memory components (e.g., DRAM or SRAM)), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fibre optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the data analytics system 200 and its various components such as the computer system 202 and the database 204 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A data analytics system configured to digitally transform research and developmental data, comprising:
a communication interface;
a memory comprising executable instructions; and
a processor communicably coupled to the communication interface and the memory, the processor comprising:
a data pre-processing engine configured to access the research and developmental data from a data source and convert the research and developmental data into a machine-understandable format;
a mathematical engine configured to analyze the research and developmental data to obtain operational distribution of risk, uncertainties, and resource demand;
an analytical engine configured to:
quantify a unit return on investment (ROI) on research and developmental investment and operational deficiency; and
transform the research and developmental data for visualization, optimization, and distribution mapping of efficiency, productivity, and cost;
a predictive engine configured to forecast emerging product opportunities and future new product sales; and
an artificial intelligence/machine learning (AI/ML) engine configured to facilitate visualization of business intelligence data in real-time on a user device, wherein the business intelligence data is generated using the research and developmental data.

2. The data analytics system as claimed in claim 1, wherein input random variables for the mathematical engine are selected from new product size, new opportunity forecast size, research and development (R&D) resource scaling factor, R&D resource coefficient, minimum initial R&D resource required, probability of success for a new product, risk sensitivity coefficient, or combination thereof.

3. The data analytics system as claimed in claim 1, wherein output random variables for the mathematical engine are selected from R&D efficiency, R&D productivity, new product sales, unit return on R&D investment, or combination thereof.

4. The data analytics system as claimed in claim 1, wherein a mathematical model comprising a plurality of formulae is utilized by the mathematical engine to obtain the operational distribution of risk, uncertainties, and resource demand

5. The data analytics system as claimed in claim 1, wherein input for the analytical engine is selected from new product size, new opportunity forecast size, number of new opportunities, year, quarter, R&D resource demand coefficient, minimum R&D resource required, initiation probability of success, risk sensitivity coefficient, or combination thereof.

6. The data analytics system as claimed in claim 1, wherein output for the analytical engine is selected from R&D efficiency, R&D productivity, return on R&D investment, unit return on R&D investment, or combination thereof.

7. The data analytics system as claimed in claim 1, wherein input for the predictive engine is selected from voice of market, voice of customer, marketing forecast, financial target, macroeconomic condition, competitions, sales, marketing & tech service, number of new products launched, sales of each newly launched product, or combination thereof.

8. The data analytics system as claimed in claim 1, wherein output for the predictive engine is selected from new product sales forecast, R&D productivity forecast, R&D efficiency forecast, risk, uncertainty distribution forecast, or combination thereof.

9. The data analytics system as claimed in claim 1, wherein the data analytics system is further caused to process one or a combination of voice of customer, voice of market, marketing forecast, and financial target in real-time using the AI/ML engine.

10. The data analytics system as claimed in claim 1, wherein the data analytics system is used as an Enterprise Resource Planning platform (ERP) for optimizing R&D operations.

11. The data analytics system as claimed in claim 1, wherein the data analytics system is used as a digital twin.

12. The data analytics system as claimed in claim 1, wherein the data analytics system is used as an Enterprise Strategic Planning (ESP) platform for optimizing strategic planning

13. The data analytics system as claimed in claim 1, wherein the research and developmental data is collected from a customer relationship management (CRM) software of a company.

14. A computer-implemented method comprising:
accessing, by a data analytics system, research and developmental data from a data source and converting the research and developmental data into a machine-understandable format;
analyzing, by the data analytics system via a mathematical engine, the research and developmental data to obtain operational distribution of risk, uncertainties, and resource demand;
quantifying, by the data analytics system via an analytical engine, unit return on investment (ROI) based, at least in part, on research and developmental investment and operational deficiency;
transforming, by the data analytics system via the analytical engine, the research and developmental data for visualization, optimization, and distribution mapping of efficiency, productivity, and cost;
forecasting, by the data analytics system via a predictive engine, emerging product opportunities and future new product sales; and
facilitating, by the data analytics system via artificial intelligence/machine learning (AI/ML) engine, visualization of business intelligence data in real-time on a user device, wherein the business intelligence data is generated using the research and developmental data.

15. The computer-implemented method as claimed in claim 14, wherein input random variables for the mathematical engine are selected from new product size, new opportunity forecast size, research and development (R&D) resource scaling factor, R&D resource coefficient, minimum initial R&D resource required, probability of success for a new product, risk sensitivity coefficient, or combination thereof.

16. The computer-implemented method as claimed in claim 14, wherein output random variables for the mathematical engine are selected from R&D efficiency, R&D productivity, new product sales, unit return on R&D investment, or combination thereof.

17. The computer-implemented method as claimed in claim 14, wherein a mathematical model comprising a plurality of formulae is utilized by the mathematical engine to obtain the operational distribution of risk, uncertainties, and resource demand

18. The computer-implemented method as claimed in claim 14, wherein input for the analytical engine is selected from new product size, new opportunity forecast size, number of new opportunities, year, quarter, R&D resource demand coefficient, minimum R&D resource required, initiation probability of success, and risk sensitivity coefficient, or combination thereof.

19. The computer-implemented method as claimed in claim 14, wherein output for the analytical engine is selected from R&D efficiency, R&D productivity, return on R&D investment, unit return on R&D investment, or combination thereof.

20. The computer-implemented method as claimed in claim 14, wherein input for the predictive engine is selected from voice of market, voice of customer, marketing forecast, financial target, macroeconomic condition, competitions, sales, marketing & tech service, number of new products launched, sales of each newly launched product, or combination thereof.

21. The computer-implemented method as claimed in claim 14, wherein output for the predictive engine is selected from new product sales forecast, R&D productivity forecast, R&D efficiency forecast, risk, and uncertainty distribution forecast, or combination thereof.

22. The computer-implemented method as claimed in claim 14, wherein the data analytics system is further caused to process one or a combination of voice of customer, voice of market, marketing forecast, financial target, research, and developmental data in real-time using the AI/ML engine.

23. The computer-implemented method as claimed in claim 14, wherein the research and developmental data is collected from a customer relationship management (CRM) software of a company.

24. A data analytics system configured to digitally transform research and developmental data, comprising:
a communication interface;
a memory comprising executable instructions; and
a processor communicably coupled to the communication interface and the memory, the processor comprising:
a data pre-processing engine configured to access the research and developmental data from a data source;
a mathematical engine configured to analyze the research and developmental data;
a predictive engine; and
an artificial intelligence/machine learning (AI/ML) engine.

25. A computer-implemented method to digitally transform research and developmental data for generating business intelligence data, the method comprising:
accessing, by a data analytics system, research and developmental data from a data source and converting the research and developmental data into business metrics and targets;
analyzing, by the data analytics system via a mathematical engine, the research and developmental data;
quantifying, by the data analytics system via an analytical engine on return of research and developmental investment and operational deficiency;
transforming, by the data analytics system via the analytical engine, the research and developmental data;
forecasting, by the data analytics system via a predictive engine, emerging product opportunities and future new product sales; and
facilitating, by the data analytics system via an artificial intelligence/machine learning (AI/ML) engine, visualization of business intelligence data in real-time on a user device, wherein the business intelligence data is digitally transformed from the research and developmental data.
